(19) United States
(12) Patent Application Publication
(10) Pub. No.: US 2013/0121101 A1
(43) Pub. Date: May 16, 2013

(54) PRESCRIPTION MANAGEMENT SYSTEM FOR PLANT TREATMENT MIXTURES

(71) Applicant: AGRILEAD, INC., Russell, KS (US)

(72) Inventors: Jeff Ochampaugh, Russell, KS (US); Norman Wagoner, Alleman, IA (US)

(73) Assignee: AGRILEAD, INC., Russell, KS (US)

(21) Appl. No.: 13/679,554

(22) Filed: Nov. 16, 2012

Related U.S. Application Data
(60) Provisional application No. 61/560,598, filed on Nov. 16, 2011.

(51) Int. Cl. A01G 1/00; B01F 15/02

(52) U.S. Cl. CPC A01G 1/001; B01F 15/0227
USPC 366/141; 47/58.1 R; 366/182.1; 366/182.2

(57) ABSTRACT

A prescription management system and method enables users to create and manage seed treatment prescriptions and to automatically build a treatment mixture based on a designated treatment prescription. The prescription management system includes a supply system with access to a plurality of individual seed treatment products and a controller for actuating the supply system to transfer portions of the treatment products to a hopper tank according to the designated treatment prescription. The products are combined in the hopper tank to form the treatment mixture, which is then applied to a quantity of seeds.

### RELATED APPLICATIONS

This application claims the priority benefit under 35 U.S.C. §119(e) of U.S. Provisional Patent Application Ser. No. 61/560,598 entitled “PRESCRIPTION MANAGEMENT SYSTEM FOR PLANT TREATMENT MIXTURES,” filed Nov. 16, 2011, the entire disclosure of which is incorporated herein by reference.

### FIELD

Embodiments of the present invention relate to methods and systems for treating seeds. More particularly, embodiments of the present invention relate to methods and systems for managing seed treatment prescriptions and automatically building seed treatment mixtures based on the prescriptions.

### BACKGROUND

Recent trends in the agriculture industry have favored conservation practices, such as soil conservation techniques that prevent soil erosion and minimize soil moisture loss. Soil conservation practices often involve reduced levels of soil tillage, such as minimal-till or no-till crop production. Such practices are effective in achieving the desire conservation but may also present other challenges. Reduced soil tillage, for example, results in increased levels of field residue and soil moisture at the time of planting, which may increase the amount of plant diseases and pests present in the soil that threaten the health of the seeds and plants.

To address these changes in agricultural practices, products and techniques have been developed to make crops more resistant to diseases and pests. Genetically modified seeds, for example, have an increased tolerance for drought and biocides. Additionally, more effective biocides have been developed to protect crops in these environments. These innovations in the agricultural industry increase the cost of crop seeds and crop production, underscoring the economic importance of establishing a strong stand on the first planting.

To promote seed health and crop development during the early stages of crop growth, seed care systems and practices have been developed that protect the seeds and promote strong early growth of the plants. A common seed care practice involves treating seeds with products that protect the seeds from pests and fungus and also provide nutrients that promote strong and healthy early growth of the plant. Such seed care products are applied to external surfaces of the seeds and, when applied properly, coat the entire outer surface of the seed. Seed treatments may be suspension concentrates, with finely milled solid particles suspended into an aqueous matrix of suspension agents, the result of which is a paint-like product. Seed treatment is limited by constraints in handling systems and planting devices that may be adversely affected by the application of excessive seed care product to the seeds. Thus, to avoid product over-application and yet apply sufficient active ingredients to the seeds, the ingredients tend to be highly concentrated and, therefore costly.

Seed treatments generally fall into one of two categories: 1) pre-mixed ready to apply treatments that are ready for use as-is or that require the addition of water, and 2) “tank mix” treatments provided as separate ingredients for the user to combine into any of various seed treatment prescriptions. Pre-mixed treatments are simple and convenient to use, but may not be the most efficient or effective treatment for a particular application. The needs of a particular seed are dictated not only by the type of seed, but also the environment in which the seed will be planted. Therefore, the needs of each crop are unique. Because seed treatment ingredients may cost hundreds dollars per gallon, using a seed treatment that is not formulated to meet the specific needs of a particular crop can present a substantial extra cost to the end user, may be ineffective, or both.

One manner of addressing this problem is to offer an increased number of pre-mixed products to address a broader range of needs. This approach addresses the problem in part, but even an increased number of pre-mixed products cannot address all localized crop needs. Yet another manner of addressing the problem is to use tank mix products such that local seed retailers can mix the various ingredients to meet the particular needs of each crop. Unfortunately, mixing the concentrated treatment ingredients to form a locally prescriptive treatment is a specialized process that is beyond the capabilities of most seed treatment operators. Therefore, there is a need for improved seed care systems and methods that do not suffer from these limitations.

The above section provides background information related to the present disclosure which is not necessarily prior art.

### SUMMARY

One embodiment of the present invention concerns a method of preparing a treatment mixture suitable for application to plants in embryonic or post embryonic states. The method comprises (a) providing a plurality of discrete treatment ingredients, wherein the treatment ingredients include at least one biocide and/or at least one plant growth enhancer, (b) providing an electronic system comprising a user interface and a controller, (c) using the controller, selecting a desired product prescription from an electronic database containing a plurality of unique product prescriptions, wherein the desired product prescription includes information about the identity and quantity of two or more of the treatment ingredients associated with the treatment mixture, and (d) combining two or more of the treatment ingredients in a hopper tank according to the desired product prescription to thereby form a batch of the plant treatment mixture, wherein the combining is at least partly directed by the controller and/or by the input device.

Another embodiment of the present invention concerns an apparatus for preparing a treatment mixture suitable for application to plants in embryonic or post embryonic states. The apparatus comprises a hopper tank, a supply system for supplying treatment ingredients from a plurality of different sources to said hopper tank, a tank evacuation system for evacuating said plant treatment mixture from said hopper tank, and an electronic system comprising a user interface and a controller. The electronic system is configured to receive operator input from the user interface, and, based on the operator input, select a desired product prescription from an electronic database containing a plurality of product prescriptions. The electronic system is further configured to control the supply system in accordance with the desired product prescription to form the plant treatment mixture in the hopper tank, and control the tank evacuation system to remove the plant treatment mixture from the hopper tank.

Another embodiment of the invention concerns a method of preparing a seed treatment slurry and applying the seed treatment slurry to seeds. The method comprises (a) providing a plurality of discrete treatment ingredients, wherein the treatment ingredients include at least one biocide and/or at least one plant growth enhancer; (b) providing an electronic system comprising a user interface and a controller; (c) using the electronic system to direct mixing of two or more of the treatment ingredients in a hopper tank to thereby form a batch of the treatment mixture; (d) transferring the seed treatment mixture from the hopper tank to an application tank via a slurry transfer conduit; and (e) applying the seed treatment mixture from the application tank to seeds in a seed treating system.

Still another embodiment of the invention concerns a system for preparing a seed treatment slurry and applying the seed treatment slurry to seeds. The system comprises a prescription management system and a seed treating system. The prescription management system comprises a hopper tank, a liquid supply system for supplying liquid treatment ingredients from a plurality of different sources to the hopper tank, and an electronic system comprising a user interface and a controller, wherein the controller at least partially controls the operation of the liquid supply system. The seed treating system comprises an application chamber for applying the seed treatment slurry to seeds, a seed conveyor for providing seeds to the application chamber, an application tank for holding a quantity of the seed treatment slurry, and a slurry transfer system for transferring the seed treatment slurry from the application tank to the application chamber. A slurry transfer conduit provides fluid flow communication between the hopper tank and the application tank.

Yet another embodiment of the invention concerns a method for preparing a treatment mixture suitable for application to plants in embryonic or post embryonic states. The method comprises (a) providing a plurality of discrete treatment ingredients, wherein the treatment ingredients include at least one biocide and/or at least one plant growth enhancer; (b) providing an electronic system comprising a user interface, a memory, and a controller; and (c) operating the electronic system in a dispatcher mode, wherein the operating in the dispatcher mode includes at least one of inputting customer information into the memory using the input device; inputting information specific to a treatment product into the memory using the input device; inputting a product prescription into the memory using the input device, and accessing information about past batches or transactions stored in the memory.

The method further comprises (d) operating the electronic system in an operating mode, wherein the operating in the operating mode includes at least one of inputting an operator password using the input device; selecting a customer stored in the memory; selecting a desired product prescription from a plurality of product prescriptions stored in the memory; selecting a build approach to determine whether the quantity of the plant treatment mixture is to be determined by volume or by number of seed units; selecting whether the desired product prescription is SIRA eligible; selecting an application vessel to which the plant treatment mixture is to be transferred; preparing a batch of the plant treatment mixture based on the desired product prescription; transferring the batch of the plant treatment mixture to the application vessel; and generating a batch report containing information about the batch of the plant treatment mixture.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### DRAWINGS

Embodiments of the present invention are described in detail below with reference to the attached drawing figures, wherein:

FIG. 1 is a block diagram of a seed care system constructed in accordance with an embodiment of the invention.

FIG. 2 is a block diagram of an exemplary prescription management system for use with the seed care system of FIG. 1.

FIG. 3 is a block diagram of an exemplary seed treating system for use with the seed care system of FIG. 1.

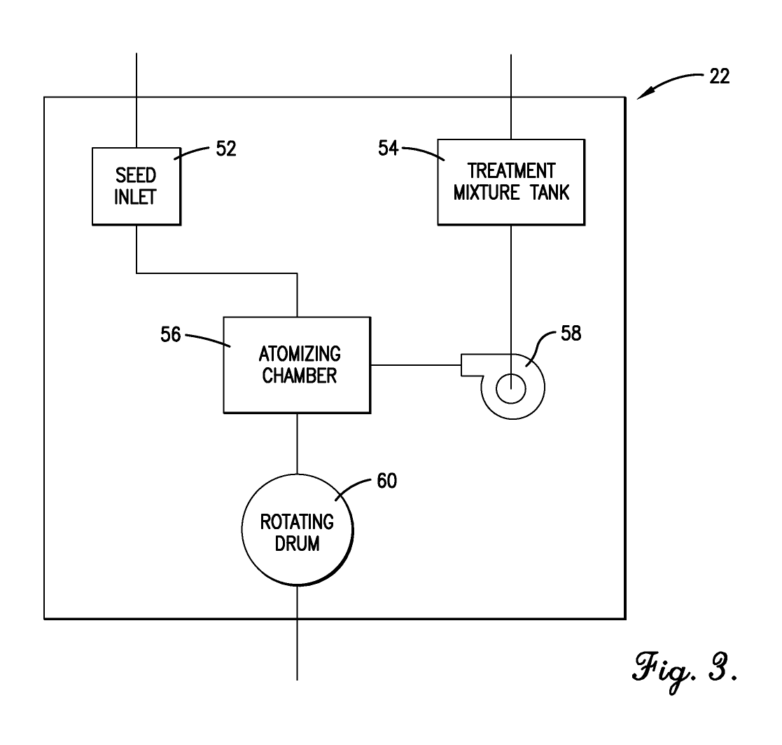

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Various embodiments of the present invention concern systems and methods for treating agricultural seed with various types of seed care products or treatments. Although reference is generally made herein to “seeds,” embodiments of the present invention may be used with plants in an embryonic state (seeds) as well as plants in certain post-embryonic states. As used herein, the term seed “treatment” may be used both as a noun to generically refer to various types of seed care products as well as a verb to describe the process by which seed care products are applied to agricultural seed.

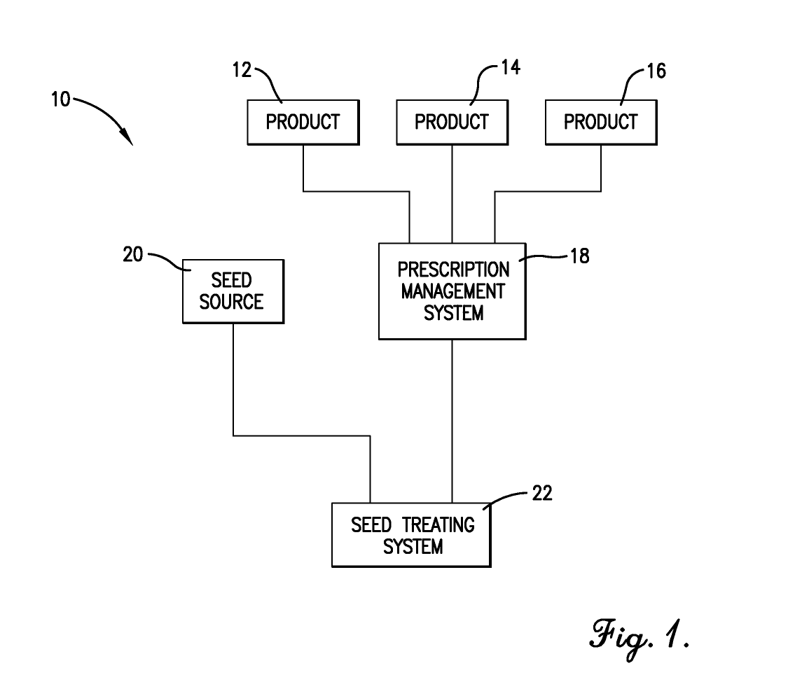

Turning now to the drawing figures, and initially FIG. 1, a seed care system 10 constructed in accordance with embodiments of the invention is illustrated. The seed care system 10 broadly includes a plurality of treatment product containers 12, 14, 16, a prescription management system 18 for receiving treatment products from the treatment product containers 12, 14, 16 and combining the products to form a seed treatment mixture, a seed source 20 and a seed treating system 22 for treating seeds received from the seed source 20 with a seed treatment mixture received from the prescription management system 18.

The product containers 12, 14, 16 are operable to dispense or make available to the prescription management system 18 a plurality of individual seed treatment products. Each of the containers 12, 14, 16 separately stores and dispenses one of the seed treatment products so that the prescription management system 18 may combine the products according to any of various different product prescriptions, as explained below. While embodiments of the invention illustrated and described herein include three product containers operably communicating with the prescription management system 18, it will be appreciated that more or fewer containers may be associated with the prescription management system 18. Furthermore, not all of the product containers associated with the prescription management system 18 may be used in any given build operation. Only two of the three product containers 12, 14, 16 may be used in a given operation, or the system 10 may include only two product containers. Similarly, the system 10 may include four, five, six, seven, eight or more product containers for use with the prescription management system 18.

The product containers 12, 14, 16 are preferably configured to be easily coupled with and decoupled from the prescription management system 18 such that each of the containers 12, 14, 16 may be quickly and easily added to and removed from the system and replaced with different containers. Thus, the number of product containers associated with the prescription management system may change over time and during the normal course of operation. In some embodiments wherein the seed treatment products are liquids, the containers are coupled with the prescription management system using dry disconnect fittings to minimize or prevent user exposure to the seed treatment products which, in some instances, may be harmful to humans.

The product containers 12, 14, 16 may be of uniform size and configuration or each of the containers may present a unique size and configuration. By way of example, the product containers may be drums, totes, or intermediate bulk containers used by treatment product manufacturers to package and ship the treatment products. The product containers may have virtually any capacity and, in certain embodiments, have a capacity of between one gallon and 100 gallons. Particularly, each of the product containers 12, 14, 16 may have a capacity of 5 gallons, 10 gallons, 20 gallons, 40 gallons, 50 gallons or 60 gallons.

Any seed treatment products known or hereafter discovered in the art can be employed in the various embodiments described herein. For example, suitable seed treatments can include a fungicide, an insecticide, a nematicide, a rodenticide, a plant growth regulator, a nutritional, a growth enhancer, a dye, a colorant, a flow control agent, a dust control agent, an encrusting agent, a pelleting agent, or mixtures of two or more thereof. In various embodiments, a plurality of such seed treatments can be applied to the seed. Additionally, seed treatments can be in the form of a solid (e.g., a dry powder) or a liquid (e.g., a solution, suspension, or slurry). Commercially available examples of such seed treatment products include, but are not limited to, MACHO 600ST from Albaugh, TRILEX 2000 from Bayer Crop Science, ALLEGIANCE FS from Bayer Crop Science, GAUCHO 600 FS from Bayer Crop Science, GAUCHO XT from Bayer Crop Science, RAXIL MD from Bayer Crop Science, AXCESS from BASF, ACQUIRE from BASF, STAMINA from BASF, CHARTER from BASF, RANCONA 3.8FS from Chemtura, ATTENDENT 480FS from Chemtura, BELMONT 2.7FS from Chemtura, SENATOR 600 FS from Nufarm, SEBRING 2.65 ST from Nufarm, SATIVA M RTU from Nufarm, SATIVA IM Max from Nufarm, APRON XL from Sygenta, APRON MAXX RFC from Sygenta, CRUISER MAXX BEANS from Sygenta, CRUISER SFS from Sygenta, DIVIDEND EXTREME from Sygenta, MAXIM 4FS from Sygenta, NIPSIT INSIDE from Valent, and RANCONA EXTRA from Valent.

In various embodiments, the seed treatment products can be manufactured by the same entity that applies the seed treatment product to the selected seed. In various other embodiments, the seed treatment producer and the seed treatment applicator can be different entities. For example the applicator of the seed treatment product can be a seed distributor, a seed retailer, or a grower (e.g., a farm operation).

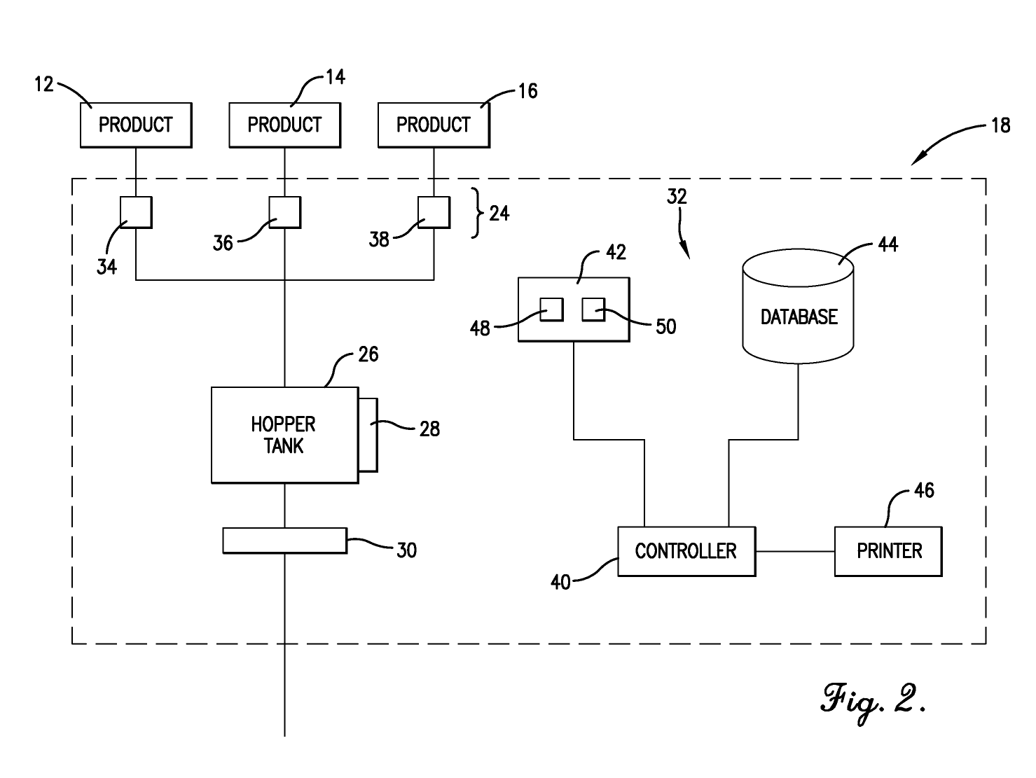

With particular reference now to FIG. 2, the prescription management system 18 broadly includes a supply system 24, a hopper tank 26, a weight sensing mechanism 28 for measuring the weight of the hopper tank 26 or contents of the hopper tank 26, a hopper tank evacuation mechanism 30 for removing contents of the hopper tank 26, and an electronic system 32 for managing and controlling operation of the prescription management system 18.

The supply system 24 is operably coupled with the product containers 12, 14, 16 and the hopper tank 26 to control or regulate transfer of the seed treatment products from the product containers 12, 14, 16 to the hopper tank 26. The supply system 24 includes a plurality of transfer mechanisms 34, 36, 38 each individually coupled with one of the product containers 12, 14, 16 for controlling or regulating transfer of the product from that container to the hopper tank. The transfer mechanisms 34, 36, 38 may be, for example, pumps for pumping the treatment products or valves for regulating flow of the products. Valves may be used, for example, if the product containers 12, 14, 16 are pressurized or positioned for gravity feed to the supply system 24. In the illustrated embodiment, the supply system 24 includes three transfer mechanisms 34, 36, 38 each associated with one of the product containers 12, 14, 16 and operable to control or regulate transfer of the product contained in the respective container to the hopper tank 26. Each of the transfer mechanisms is in communication with, and controlled by, the electronic system 32, as explained below in greater detail.

The seed treatment products transferred from the product containers 12, 14, 16 are combined in the hopper tank 26 according to a product prescription. The weight sensing mechanism 28 associated with the hopper tank 26 detects the weight of the tank 26 or the contents of the tank 26 and is used, for example, to detect or measure an amount of each of the products added to the tank 26 from the product containers 12, 14, 16. In various embodiments of the invention, the weight sensing mechanism 28 includes one or more scale modules for detecting the weight, wherein the hopper tank 26 is suspended by or on the one or more scale modules. The weight sensing mechanism 28 communicates weight information to the electronic system 32 which uses the weight information to control operation of the supply system 24, as explained below in greater detail. The hopper tank 26 may have a capacity within the range of from about one gallon to about 100 gallons. In various embodiments, the preferred capacity of the hopper tank 26 is about 10 gallons, about 20 gallons, about 30 gallons or about 40 gallons.

The hopper tank 26 may present an open configuration, such as where a top of the tank 26 is partially or completely open, or may present a closed configuration wherein the tank 26 is completely enclosed and may be hermetically sealed. In various embodiments of the invention the hopper tank 26 is configured to receive seed treatment products from the supply system 24 as well as via manual input, such as where a user manually pours one or more treatment products into the hopper tank 26 during operation. In those embodiments the hopper tank 26 is configured with appropriate access, such as a completely or partially open top, an inlet conduit on a top or side wall of the tank 26, and/or a door on a top or side wall of the tank 26.

The hopper tank evacuation mechanism 30 is operable to control or regulate transfer of the contents of the hopper tank 26 to the seed treating system 22. The evacuation mechanism 30 may include one or more pumps for pumping the contents of the hopper tank 26 through an exit conduit. Alternatively or additionally, the evacuation mechanism 30 may include one or more valves for regulating flow of the contents of the hopper tank 26 to the exit conduit. In some embodiments, the evacuation mechanism 30 is in communication with, and controlled by, the electronic system 32. Alternatively, the evacuation mechanism 30 may be manually controlled.

Any of the seed treatment products provided in the product containers 12, 14, 16 or the seed treatment mixture in the hopper tank 26 may be a relatively lightweight liquid or may have a thicker consistency, such as a slurry or a suspension. Therefore, the components of the supply system 24, including the transfer mechanisms 34, 36, 38, and the components of the hopper tank evacuation mechanism 30 are preferably suited to handle a wide range of products and product mixtures presenting an array of weights and viscosities. Any pumps used in the supply system 24 and the evacuation mechanism 30, for example, should be suitable for use with lightweight liquids as well as slurries.

The electronic system 32 broadly includes a controller 40, a user interface 42, a database 44 and a printer 46. The controller 40 communicates with and controls each of the other components of the electronic system 32 as well as various other components of the prescription management system 18 such as elements of the supply system 24, the weight sensing mechanism 28 and the tank evacuation mechanism 30, as explained below in greater detail. The controller 40 preferably comprises one or more digital integrated circuits such as programmable logic devices, application specific integrated circuits (ASICs), or general purpose computer processors. The functionality of the controller 40 as described herein may be implemented in hardware, firmware, software or a combination thereof.

In various embodiments of the invention, the controller 40 is or includes one or more general purpose computers or computer processors programmed to perform the functions described herein. Particularly, the controller 40 may be or include a desktop, laptop, netbook, or tablet computer running one or more computer programs designed to enable the controller 40 to perform the functions described herein. Thus, aspects of the invention may be implemented with one or more computer programs stored in or on a computer-readable medium residing on or accessible by the controller 40. Each computer program preferably comprises an ordered listing of executable instructions for implementing logical functions in the controller 40. Each computer program can be embodied in any non-transitory computer-readable medium for use by or in connection with the controller 40. In the context of this document, a “computer-readable medium” can be any non-transitory means that can store the program for use by or in connection with the instruction execution system, apparatus, or device. The computer-readable medium can be, for example, but is not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The user interface 42 enables human interaction with the controller 40 and with the other components of the prescription management system 18 via the controller 40. The user interface 42 includes an input device or function 48, an output device or function 50, or a combination of input and output devices or functions. In various embodiments of the invention the user interface 42 is a touchscreen with both input and output capabilities. Other input and output devices may be used without departing from the scope of the invention, including keypads and non-touch enabled display devices. If the controller 40 is or includes a laptop or netbook computer, for example, the user interface may include a standard QWERTY computer keyboard and computer display.

The database 44 is a collection of information organized in such a way that the controller 40 can quickly select or manipulate desired pieces of data. The database 44 is contained on one or more computer-readable media such as a hard drive or a series of hard drives accessible by the controller 40, and may be loaded by the controller 40 into local memory more easily accessible by the controller 40. The database 44 may be stored in the same physical location as the prescription management system 18 or may be stored remotely from the other components of the prescription management system 18 and accessed via one or more communications protocols, such as the Internet. By way of example, the database 44 may store information relating to the individual seed treatment products, information relating to product prescriptions, information relating to customers and customer accounts, historical information relating to product or prescription use, or a combination thereof.

The seed treating system 22 is operable to receive seed treatment mixtures from the prescription management system 18 and apply the seed treatment mixtures to seeds received from the seed source 20. The configuration and functionality of the seed treating system 22 may vary from one implementation of the invention to another without departing from the scope of the invention. The illustrated embodiment of the seed treating system 22 is conventional in nature and therefore will be discussed only briefly. The seed treating system 22 broadly includes a seed inlet 52, a treatment mixture tank 54, an atomizing chamber 56, a pump 58 for transferring seed treatment mixture from the treatment mixture tank 54 to the atomizing chamber 56, and a rotating drum 60 or similar mechanism for mixing the seeds after the treatment mixture has been applied to the seeds.

The treatment mixture tank 54 receives seed treatment from an external source, such as the prescription management system 18, and holds the seed treatment mixture 54 until the pump 58 transfers the treatment mixture to the atomizing chamber 56. The seed inlet 52 receives seeds from an external source, such as the seed source 20, and feeds the seeds to the atomizing chamber 56. The atomizing chamber 56 receives the seed treatment mixture from the treatment mixture tank 54, receives the seeds from the seed inlet 52, and applies the seed treatment mixture to the seeds by atomizing the seed treatment and spraying the seed treatment onto the seeds as the seeds pass through the atomizing chamber 56. The treated seeds pass to the rotating drum 60 where they are further mixed or “tumbled” such that the seeds rub against one another to ensure that the seed treatment is applied evenly to the entire surface of each of the seeds.

The prescription management system 18 is operable to assist users in building custom seed treatment prescriptions, to manage an unlimited number of unique seed treatment prescriptions, and to automatically build any of the seed treatment prescriptions into ready-to-apply seed treatment mixtures. The prescription management system 18 generally operates under the direction of the controller 40 according to user input submitted via the user interface. The functionality of the system 18 can generally be divided into two modes, including dispatcher mode and operating mode.

In dispatcher mode, the controller 40 enables users to setup various parameters of the prescription management system 18 and to generate reports. Setting up the prescription management system 18 may include submitting crop and seed specifications, product specifications, seed treatment prescription definitions, user account information and customer account information.

The crop and seed specifications may include crop name and seed treatment information. The seed treatment information may include standard unit information, seed count information and standard application rates. A standard seed unit may be fifty pounds, for example, and the number of seeds per pound (seed count) may range from less than one thousand to over one million, depending on the particular type of seed. Table 1, below, provides a list of crops with exemplary seed counts for each crop express in seeds per pound for each of the crops:

TABLE 1
Sample Seed Count Chart

| Crop | | Seeds per Pound |
|---|---|---|
| Grain Crops | Barley | 13,500 |
| | Corn | 1,500 |
| | Oat | 12,700 |
| | Rye | 18,000 |
| | Sorghum | 14,000 |
| | Sunflower | 6,000 |
| | Wheat | 12,000 |
| | Alfalfa | 220,00 |
| Forage Crops | Birdsfoot trefoil | 1,000,000 |
| | Bromegrass | 137,000 |
| | Fescue, tall | 226,800 |
| | Ladino clover | 860,000 |
| | Orchardgrass | 590,000 |
| | Red clover | 270,000 |
| | Reed canarygrass | 550,000 |
| | Sudan grass | 50,000 |
| | Timothy | 1,230,000 |
| | Vetch, hairy | 20,000 |

As illustrated in Table 1, the number of seeds per pound may vary substantially from one crop to another and from one type of crop to another. The values in Table 1 are exemplary in nature and actual grain counts may vary from those listed in Table 1 and, in fact may vary from one unit of seeds to another.

The product specifications may include a name, description and manufacturer of each product. Product descriptions may include a product code, an indication of pounds per gallon, a dispensing order, prescription units such as fluid ounces and an EPA registration number. The product specifications may also include packaging and interconnection information, including the size of a standard container of each package and the size or type of interconnects associated with the containers used to connect the containers to the supply system 24. If a product container is connected to the prescription management system 18, the product specifications may further indicate a supply system port or connector associated with that product container. This information is necessary to enable the controller 40 to actuate the appropriate transfer mechanism 34, 36, 38 to transfer product from the product container to the hopper tank 26.

Some product containers are connected to the prescription management system 18 to enable the system 18 to automatically add the product to the hopper tank 26, while other product containers may be designed as “manual add” containers, wherein the containers are not connected to the prescription management system 18 but rather are available for users to manually add the products contained therein to the hopper tank 26 when prompted by the electronic system 32. Thus, the packaging and interconnect information associated with each prescription would also include a designation of whether the product is a manual-add product.

To submit a seed treatment prescription definition to the system, a user first enters a prescription name and selects a crop associated with the prescription. A seed treatment prescription is a description of the various treatment products that are combined to form a desired treatment mixture, including an amount of each product which may be expressed, for example, in fluid ounces per hundredweight of seed. The user then indicates a total prescription volume and selects one or more products that comprise the prescription. When selecting each treatment product for the prescription, the user indicates an amount, such as fluid ounces, to be included in the prescription. Each prescription may include water as one of the ingredients, and the system 18 may automatically determine the amount of water as the difference between the sum of the selected product quantities and the total prescription volume. By way of example, each prescription may include between one weight percent and ninety-five weight percent of water. More particularly, each prescription may include five, ten, twenty, thirty, seventy, eighty or ninety weight percent water. Each prescription will typically be linked to or otherwise associated with one or more particular crops for which the prescription was developed, and may include a standard application rate. The application rate may be modified by the system, however, to accommodate different seed sizes.

Each prescription definition submitted to the electronic system 32 may include an indication of whether the prescription is eligible for a size indexed rate adjustment seed treatment method, or “SIRA.” The SIRA seed treatment method involves adjusting the application rate of a prescription according to the size of the unit or batch of seeds to be treated. The optimal application rate of a seed treatment will typically depend on the size of the seeds being treated, as the seed size is inversely proportional to the total surface area of the unit of seeds being treated. Because the size of the seeds for a particular crop may vary from one unit of seeds to another, the optimal application rate will also vary from one unit of seeds to another. The SIRA method is described in U.S. patent application Ser. No. 13/269,695 (the '695 application), titled “SEED INDEX SYSTEM FOR TREATING AGRICULTURAL SEEDS.” The '695 application was filed on Oct. 10, 2011 and published on May 10, 2012 under publication number 2012/0115911. The '695 application is hereby incorporate by reference in its entirely.

The SIRA seed treatment method broadly includes the steps of (a) obtaining a quantity of seeds from a seed supplier, (b) obtaining a seed care product from a seed care product supplier, (c) determining a size-adjusted application rate at which to apply the seed care product to the quantity of seeds, wherein the size-adjusted application rate is based on the seed size of the quantity of seeds, and (d) applying at least a portion of the seed care product to at least a portion of the quantity of seeds at the size-adjusted application rate to thereby provide treated seeds. The size of the seeds may be determined based on a number of seeds per unit of weight or based on actual measurements of at least a portion of the quantity of seeds.

Each of the seed treatment prescription definitions may be a standard definition provided by product manufacturers for general application across a broad geographic region, or may be localized prescriptions developed by a local seed retailer for a particular area or a particular crop. One of the advantages of the present invention is that it provides a cost-effective way for local seed retailers to mix and apply custom seed treatment mixtures at the point of sale.

In various implementations, the electronic system 32 may be accessed by a number of different users who use the prescription management system to serve different customers. Thus, each user may be required to set up an individualized customer account including the user's name and secure access information, such as a username and password. All of the user's activities may be associated with that user's account, including any product prescriptions the user used or created, client accounts accessed or created by the user, and a history of the treatment applications performed by the user. The system 32 may maintain an account associated with each customer that includes such information as a list of the product prescriptions the customer has used in the past and the particular crops associated with each of the prescriptions. Each customer account may be accessible via multiple user accounts.

In dispatcher mode the system 32 is operable to generate reports. Reports may be created relating to particular transactions or applications, particular user accounts or customer accounts, or activities occurring within a given time period such as a day, week, or month. Furthermore, reports may be crated relating to particular crops or particular prescriptions. These reports may be defined by users, created by the electronic system 32 made available via the user interface 42, the printer 46 or both. It will be appreciated by those skilled in the art that a report may include virtually any information contained in the database 44.

In operating mode, the system 18 creates seed treatment mixtures in an automated treatment build process using information submitted by the user in the dispatch mode. To create a seed treatment mixture in operating mode, a user logs into the system 32 using the secure access information so that the activity can be associated with the user's account. The user then selects a customer for whom the work is being done such that the activity can also be associated with the particular customer. The controller 40 may present a list of customers via the user interface 42 based on information submitted in the dispatcher mode and allow the user to select one of the customers.

The electronic system 32 then assists the user in selecting a prescription by presenting a list of prescriptions submitted to the system 32 in the dispatcher mode. The user selects a prescription from the list, then selects a prescription build approach. A first prescription build approach involves building a user-designated volumetric quantity of the prescription, such as a user-designated number of gallons of the prescription. A second prescription build approach involves building the prescription to treat a user-designated number of seed units. In the latter build approach, the controller 40 uses the crop and seed specifications submitted in the dispatcher mode to determine an amount of treatment mixture to build. If the user selects the second prescription build approach and the prescription is SIRA eligible, the electronic system 32 further prompts the user to submit seed size information, such as the number of seeds per pound or per unit of seed.

The controller 40 automatically builds the prescription by first actuating the transfer mechanisms 34, 36, 38 of the supply system 24 to transfer the appropriate amount of each product to the hopper tank 26. The controller 40 determines which product port is associated with a first product and actuates the corresponding transfer mechanism to transfer the required amount of that product to the hopper tank 26. The controller 40 calculates the amount of product added to the hopper tank 26 by communicating with the weight sensing mechanism 28 associated with the hopper tank 26 to detect changes in the weight of the tank 26 (or changes in the weight of the contents of the tank) as the product is added to the tank 26. Using the product weight information in the product description stored in the database 44, the controller 40 stops transfer of the product when a weight of the product corresponding to the required amount of the product has been added to the tank 26. This process is repeated for each of the products.

If one of the products in the prescription is designated “manual add,” the controller 40 prompts the user to add the product. The controller 40 provides the prompt, which may include the amount of the product to add, via the user interface 42 and waits for the user to indicate the manual-add step has been completed by, for example, selecting a “Done” button or similar element on the user interface 42. The electronic system 32 may help the user add the appropriate amount of product to the hopper tank 26 by, for example, displaying a target weight of the hopper tank 26 with the appropriate amount of product along with an actual weight of the tank 26 that changes in real time as the user adds the product. The user may then monitor the target weight and the actual weight and be apprised when the actual weight corresponds to the target weight. The controller 40 may also prompt the user to add a portion of the required water to the hopper tank 26 during the manual add process to flush residual product from the container used to dispense the product into the hopper tank 26. The user may be prompted, for example, to add a designed weight of water to the hopper tank 26 and is provided a visual indication of the amount of water added during the add process. After adding the product and the water, the user provides an input indicating that the manual add step is complete, wherein the controller 40 proceeds with the next step of the prescription building process.

If water is required by the prescription, the controller 40 adds the water to the hopper tank from, for example, a public water source or a water reservoir accessible to the supply system 24. The controller 40 may add the water to the hopper tank 26 at any point in the prescription build process and may add portions of the total required amount of water at different points in the process. It may be desirable, for example, to add a portion of the required amount of water at the beginning of the process to load pumps, valves and/or conduits with water in advance of the products, which tend to have a higher viscosity than water. It may then be desirable to add the remaining water at the end of the build process to flush the products from the supply system 24 into the hopper tank 26.

In some embodiments the prescription management system 18 may be associated with multiple seed treating systems, or may be associated with a single seed treating system with a plurality of treatment mixture tanks 54. In those embodiments, the controller 40 selects a treatment mixture tank to which the treatment mixture is transferred. It may be desirable, for example, to have a first treatment mixture tank for biocides, a second tank for nutritionals, and so forth. In these embodiments of the invention, there may be any number of treatment mixture tanks, and one of the treatment mixture tanks may be designated as part of the prescription definition information submitted by the user or, alternatively, may be designed by the user at the time the prescription is built.

The controller 40 may use a split dispensation build process by building a first portion of a prescription in the hopper tank 26, transferring the first portion of the prescription to the seed treating system or an intermediate storage tank, then building a second portion of the prescription in the hopper tank 26 and transferring the second portion to the seed treating system or intermediate storage tank. This process may be repeated for additional portions of the prescription, if necessary. The split dispensation method presents the advantage of using the hopper tank 26 to build prescriptions that exceed the capacities of the tank 26. Because the hopper tank 26 includes a weight sensing mechanism 28, it is desirable to limit the size of the tank 26 to manage costs. Using the split dispensation build process, virtually any size prescription may be built with even a relatively small hopper tank 26.

When the mixed treatment has been transferred to the seed treating system 22, it is used by the seed treating system 22 to treat seeds transferred from the seed source 20 to the treating system 22. The seed source 20 may be an upright storage tank configured to hold a bulk quantity of seeds, such as between 1,000 and 5,000 seed units each consisting of fifty pounds of seeds. Furthermore, a conveyor belt, auger, or similar mechanism may transfer seeds from the seed source 20 to the treating system 22. The treating system 22 may operate in a conventional manner, as explained above, and therefore will not be described in detail.

At the conclusion of the automated build process but before the treatment mixture is transferred from the hopper tank 26, the prescription management system 18 may perform additional cleaning or flushing steps, such as flushing components of the system 18 with air to force any residual product or water out of the components and into the hopper tank 26. Furthermore, when the treatment mixture has been transferred out of the hopper tank 26, the controller 40 may flush one or more components of the prescription management system 18 with water and/or cleaning agents which are then discarded.

After building a prescription, the controller 40 may automatically build a batch report that is stored in the database 44, printed via the printer, or both. The batch report may include, for example, the date and time of the build; operator information including the operator's name; customer information including the customer's name and address; batch calculations and specifications including seed size, target treatment units, target gallons, designated application vessel, the name and amount of each product used, and the amount of water used; and prescription design information including the prescription name, the crop, the EPA registration number of each of the products used, and the density of each of the products used.

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

Having thus described the preferred embodiment of the invention, what is claimed as new and desired to be protected by Letters Patent includes the following:

1. A method of preparing a treatment mixture suitable for application to plants in embryonic or post embryonic states, said method comprising:
(a) providing a plurality of discrete treatment ingredients, wherein said treatment ingredients include at least one biocide and/or at least one plant growth enhancer;
(b) providing an electronic system comprising a user interface and a controller;
(c) using said controller, selecting a desired product prescription from an electronic database containing a plurality of unique product prescriptions, wherein said desired product prescription includes information about the identity and quantity of two or more of said treatment ingredients associated with said treatment mixture; and
(d) combining two or more of said treatment ingredients in a hopper tank according to said desired product prescription to thereby form a batch of said plant treatment mixture, wherein said combining is at least partly directed by said controller and/or by said input device.

2. The method of claim 1, step (d) further comprising automatically adding at least one of said treatment ingredients to said hopper tank in response to commands from the controller.

3. The method of claim 1, step (d) further comprising manually adding at least one of said treatment ingredients to said hopper tank in response to information displayed on said display device.

4. The method of claim 1, step (d) further comprising automatically adding at least one of said treatment ingredients to said hopper tank in response to commands from the controller and manually adding at least one of said treatment ingredients to said hopper tank in response to information displayed on said display device.

5. The method of claim 1, further comprising generating a report of said batch of said seed treatment mixture, the report being displayed on said display device.

6. The method of claim 1, wherein at least one of said discrete treatment ingredients is in the form of solid particulates.

7. The method of claim 1, wherein at least one of said discrete treatment ingredients is in the form of a liquid.

8. The method of claim 1, wherein said treatment mixture comprises at least three of said treatment ingredients.

9. The method of claim 1, further comprising transferring said batch of said treatment mixture to an application vessel of a seed treatment system via a flow conduit.

10. The method of claim 1, wherein at least two of said treatment ingredients are each provided in individual containers.

11. The method of claim 10, each of the individual containers having a capacity of no more than 40 gallons.

12. The method of claim 1, wherein said hopper tank has a capacity of at least one gallon and not more than 50 gallons.

13. The method of claim 1, further comprising evacuating said hopper tank using a tank evacuation system controlled by said controller.

14. The method of claim 1, wherein water is present in said plant treatment mixture in an amount that is no less than five weight percent and no more than eighty weight percent.

15. An apparatus for preparing a treatment mixture suitable for application to plants in embryonic or post embryonic states, said apparatus comprising:
a hopper tank;
a supply system for supplying treatment ingredients from a plurality of different sources to said hopper tank;
a tank evacuation system for evacuating said plant treatment mixture from said hopper tank; and
an electronic system comprising a user interface and a controller, wherein said electronic system is configured to—
(i) receive operator input from said user interface,
(ii) based on the operator input, select a desired product prescription from an electronic database containing a plurality of product prescriptions,
(iii) control said supply system in accordance with said desired product prescription to form said plant treatment mixture in said hopper tank, and
(iv) control said tank evacuation system to remove said plant treatment mixture from said hopper tank.

16. The apparatus of claim 15, the supply system includes at least three liquid supply pumps operably communicating with said controller.

17. The apparatus of claim 15, further comprising a weight sensing mechanism for sensing the weight of said hopper tank.

18. The apparatus of claim 15, said plurality of different sources including a plurality of individual containers each having a capacity of not more than 40 gallons.

19. The apparatus of claim 15, said tank evacuation system including at least one evacuation pump operably communicating with said controller.

20. The apparatus of claim 15, said electronic system including an electronic database of treatment product information and treatment prescription information, said controller being configured to use the treatment product information and the treatment prescription information to automatically build the treatment mixture.

21. The apparatus of claim 15, said electronic system including an electronic database of customer information, said controller being configured to associate said plant treatment mixture with a customer in said database.

22. The apparatus of claim 15, said electronic system including an electronic database of plant information.

23. The apparatus of claim 15, said electronic system including an electronic database of information relating to previously made treatment batches.

24. A method of preparing a seed treatment slurry and applying said seed treatment slurry to seeds, said method comprising:
(a) providing a plurality of discrete treatment ingredients, wherein said treatment ingredients include at least one biocide and/or at least one plant growth enhancer;
(b) providing an electronic system comprising a user interface and a controller;
(c) using said electronic system to direct mixing of two or more of said treatment ingredients in a hopper tank to thereby form a batch of said treatment mixture;
(d) transferring said seed treatment mixture from said hopper tank to an application tank via a slurry transfer conduit; and
(e) applying said seed treatment mixture from said application tank to seeds in a seed treating system.

25. The method of claim 24, said application tank having a capacity that is at least 1.5 times greater than the capacity of said hopper tank.

26. The method of claim 24, wherein said applying of step (d) takes place within 12 hours of said mixing of step (c).

27. The method of claim 24, wherein said applying of step (d) takes place within 250 feet of said mixing of step (c).

28. The method of claim 24, wherein said slurry transfer conduit has a length of not more than 250 feet.

29. The method of claim 24, further comprising generating a report including information about said batch of said seed treatment mixture.

30. A system for preparing a seed treatment slurry and applying said seed treatment slurry to seeds, said system comprising:
a prescription management system comprising a hopper tank, a liquid supply system for supplying liquid treatment ingredients from a plurality of different sources to said hopper tank, and an electronic system comprising a user interface and a controller, wherein said controller at least partially controls the operation of said liquid supply system;
a seed treating system comprising an application chamber for applying said seed treatment slurry to seeds, a seed conveyor for providing seeds to said application chamber, an application tank for holding a quantity of said seed treatment slurry, and a slurry transfer system for transferring said seed treatment slurry from said application tank to said application chamber; and
a slurry transfer conduit for providing fluid flow communication between said hopper tank and said application tank.

31. The system of claim 30, wherein said slurry transfer conduit has a length of not more than 250 feet.

32. A method for preparing a treatment mixture suitable for application to plants in embryonic or post embryonic states, said method comprising:
(a) providing a plurality of discrete treatment ingredients, wherein said treatment ingredients include at least one biocide and/or at least one plant growth enhancer;
(b) providing an electronic system comprising a user interface, a memory, and a controller;
(c) operating said electronic system in a dispatcher mode, wherein said operating in said dispatcher mode includes at least one of—
(i) inputting customer information into said memory using said input device,
(ii) inputting information specific to a treatment product into said memory using said input device,
(iii) inputting a product prescription into said memory using said input device,
(iv) accessing information about past batches or transactions stored in said memory; and
(d) operating said electronic system in an operating mode, wherein said operating in said operating mode includes at least one of—
(i) inputting an operator password using said input device,
(ii) selecting a customer stored in said memory,
(iii) selecting a desired product prescription from a plurality of product prescriptions stored in said memory,
(iv) selecting a build approach to determine whether the quantity of said plant treatment mixture is to be determined by volume or by number of seed units,
(v) selecting whether said desired product prescription is SIRA eligible,
(vi) selecting an application vessel to which said plant treatment mixture is to be transferred,
(vii) preparing a batch of said plant treatment mixture based on said desired product prescription,
(viii) transferring said batch of said plant treatment mixture to said application vessel, and
(ix) generating a batch report containing information about said batch of said plant treatment mixture.

33. The method of claim 32, wherein said preparing of said batch of said plant treatment mixture comprises at least one of—
(a) automatically adding a treatment ingredient to a hopper tank,
(b) manually adding a treatment ingredient to said hopper tank,
(c) determining the amount of said treatment ingredient added to said hopper tank by measuring the weight of said hopper tank, and
(d) rinsing said hopper tank with water.
